(19) United States
(12) Patent Application Publication
(10) Pub. No.: US 2005/0116567 A1
(43) Pub. Date: Jun. 2, 2005

(54) Magnetic engine

(76) Inventor: Allan Limb, Launceston, Tasmania (AU)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/499,238

(22) PCT Filed: Dec. 18, 2002
(86) PCT No.: PCT/AU02/01717

(30) Foreign Application Priority Data
Dec. 19, 2001 (AU) PR 9641

(51) Int. Cl. H02K 7/06; H02P 15/00; H02K 21/00

(52) U.S. Cl. 310/152; 310/80; 310/103

(57) ABSTRACT

A magnetic engine is disclosed which includes a first permanent magnet (10) and a second element (12) which may also be in the form of a permanent magnet or a member made from magnetically attractable material (201). An output (51, 250) is provided for providing output rotary motion. A flux altering means in the form of circular valve discs (16) are provided for movement into and out of registry with the magnet (10) for relocating magnetic flux produced by the magnet (10) away from the element (12, 201) so as to change the magnetic attraction or repulsion experienced by the element (12, 201) between movement towards the valve (10) and away from the valve (10) to thereby produce a net power input which can be supplied to the output (51, 250) to provide output from the engine. Also disclosed are various engine configurations in accordance with the above principle, and a crank configuration for increasing the efficiency of an engine regardless of whether the engine is of the internal combustion type or a magnetic engine.

### FIELD OF THE INVENTION

This invention relates to a magnetic engine.

### BACKGROUND ART

Most conventional engines in use today are either internal combustion engines or electric powered motors or engines.

The object of the present invention is to provide an engine which operates on magnetic force and which does not require additional fuel or energy input, other than the magnetic force in order to operate the engine.

### SUMMARY OF THE INVENTION

The invention may be said to reside in an engine including:
a first permanent magnet;
a second element movable relative to the magnet towards and away from the magnet;
an output for providing output rotary power due to relative movement between the magnet and the element; and
flux altering means for movement into and out of registry with the magnet for relocating magnetic flux produced by the magnet away from the element so that when the flux altering means is registered with the magnet, the flux produced by the magnet and to which the element is exposed is decreased, and upon movement of the flux altering means out of registry with the magnet, the magnetic flux of the magnet to which the element is exposed is increased, thereby providing a larger force between the magnet and the element to provide the output rotary power at the output.

In one embodiment, the element comprises a second permanent magnet mounted for reciprocating movement with respect to the first permanent magnet, and the output is coupled to the second permanent magnet to convert the reciprocating movement of the second permanent magnet to rotary movement at the output.

In another embodiment, the element comprises a ferromagnetic element which is attracted towards the magnet and which passes the magnet, and wherein as the element passes the magnet, the flux altering means moves into registry with the magnet to reduce the attraction between the magnet and the element to thereby enable the element to continue past the magnet to provide output rotary power at the output.

The engine according to the present invention therefore operates on the basis of magnetic flux produced by the permanent magnet without the need to provide additional fuel. The “compression stroke” of the engine is provided by moving the flux altering means into registry with the first magnet to effectively relocate the flux away from the element and decrease the magnetic flux which is exposed to the element from the first magnet so that the element can more easily move relative to the first magnet, and upon retraction of the flux altering means to a position out of registry with the first magnet, the amount of magnetic flux exposed to the element is restored, thereby providing a greater force to move the element away from the first magnet to thereby provide the power stroke of the engine.

The invention may also be said to reside in an engine including:
a first permanent magnet;
a piston including a second permanent magnet, the second magnet being arranged with respect to the first magnet so that same poles of the first and second magnets face one another;
mounting means for mounting the piston and second magnet for reciprocating movement relative to the first magnet;
an output coupled to the piston for providing output power; and
flux altering means for movement into and out of registry with the first permanent magnet for relocating magnetic flux produced by the first magnet away from the second magnet, so that when the flux altering means is registered with the first magnet the magnetic flux produced by the first magnet and to which the second magnet is exposed is decreased, and upon movement of the flux altering means out of registry with the magnet, the magnetic flux of the first magnet to which the second magnet is exposed is increased thereby providing a larger repelling force between the first and second magnets to thereby provide an output power stroke.

In one embodiment of the invention the flux altering means comprises a plurality of discrete elements, and means for guiding movement of the discrete elements from a position adjacent a periphery of the first magnet, to a position inwardly of the periphery of the first magnet. In the preferred embodiment of the invention these elements will be called valves because they operate in a somewhat similar sense to conventional moveable valves in an internal combustion engine to provide a power stroke and a compression stroke of the engine.

The valves are preferably formed from magnetisable material such as ferrous material.

In one embodiment of the invention the elements are in the form of discs.

In the preferred embodiment of the invention the first and second magnetics are each provided with a central hole.

In one embodiment of the invention the mounting means comprises a pair of guide rails coupled to the piston, and at least one bearing for guiding reciprocating movement of the guide rails and the piston.

Preferably the guide rails have a U-shaped end portion connecting the guide rails together.

Preferably the end portion is pivotally connected to a connecting rod at one end of the connecting rod, and the other end of the connecting rod is connected to the output.

Preferably the output comprises a crank shaft.

Preferably the flux altering means includes drive means for driving the flux altering means into registry with the first magnet and out of registry with the first magnet in synchronisation with the reciprocating movement of the piston.

In one embodiment the drive means comprises:
a rotatable element mounted for rotation in a first direction and then rotation in a second direction;
a link coupled to the rotatable element and driven by rotation of the crank shaft so as to cause the rotatable element to rotate back and forward in the said direction and reverse direction; and
a link coupled to the flux altering means and to the rotatable element so that upon rotation of the rotatable element in the first direction, the flux altering means is moved to a position adjacent the periphery of the first magnet, and upon rotation in the reverse direction, is moved to a position inward of the periphery of the first magnet.

Preferably the flux altering means has a guide element for guiding movement of the flux altering means.

In one embodiment the guide element comprises a hollow sleeve which receives a stem connected to the flux altering means for guiding movement of the flux altering means.

In another embodiment, the flux altering means is moved by a cam member which rotates in synchronisation with the output so as to move the flux altering means between the position adjacent the periphery of the first magnet to the position inwardly of the first magnet.

Preferably movement of the flux altering means in one direction is partly assisted by magnetic attraction of the first magnet so that movement of the flux altering means in said direction produces energy which is harnessed and supplied as output energy from the engine.

In this embodiment of the invention the flux altering means is coupled to a spring in which the energy is stored.

The invention may also be said to reside in an engine including:
a first permanent magnet;
a piston including a second permanent magnet, the second magnet being arranged with respect to the first magnet so that same poles of the first and second magnets face one another;
mounting means for mounting the piston and second magnet for reciprocating movement relative to the first magnet;
an output coupled to the piston for providing output power;
flux altering means for movement into and out of registry with the first permanent magnet so that when the flux altering means is registered with the first magnet the magnetic flux produced by the first magnet and to which the second magnet is exposed is decreased, and upon movement of the flux altering means out of registry with the magnet, the magnetic flux of the first magnet to which the second magnet is exposed is increased thereby providing a larger repelling force between the first and second magnets to thereby provide an output power stroke; and
wherein the first permanent magnet is a substantially circular shape and has a central hole which has a diameter one third of the diameter of the first magnet, and wherein the flux altering means, when in registry with the first magnet, encroaches on the first magnet by an amount of 20% of the radius of the first magnet, and wherein the flux altering means comprises a plurality of generally circular elements which have a diameter one third of the diameter of the first magnet.

A second aspect of the invention is concerned with increasing the power of an engine and the efficiency of an engine, regardless of whether the engine is powered by internal combustion, or by magnetic force as in the previously described invention.

This aspect of the invention may be said to reside in an engine including:
a reciprocating piston;
a rotary output member for supplying output rotary power;
connecting means for connecting the reciprocating piston to the output rotary member so that reciprocation of the piston produces rotation of the output member; and
dwell angle producing means for producing a flat dwell angle whilst the piston is at a top dead centre position so that the rotary output member rotates a significant portion of the rotary cycle of the output member before substantial movement of the piston from top dead centre position occurs so that as the piston moves away from top dead centre position under maximum power during a power stroke, the angle between the connecting means and the rotary output member approaches a maximum value so that power is delivered from the reciprocating piston whilst the piston is subject to increased force in the power stroke and whilst the angle between the connecting means and the output rotary member approaches the maximum to thereby increase output efficiency from the engine.

In one embodiment of the invention the piston may include a magnet and reciprocating movement of the piston are caused by magnetic repulsion from a further magnet.

However, in other embodiments, the piston may be powered by combustion of fuel in a cylinder to cause reciprocation of the piston in the cylinder.

In one embodiment, the coupling means comprises a connecting rod and the output rotary member comprises a crank shaft, the crank shaft having an output axel coupled to a primary crank, a secondary crank for receiving the primary crank, the connecting rod being connected to the secondary crank by a crank pin, a gear mounted in the secondary crank, and a secondary gear for meshing engagement with the gear supported by the secondary crank so that the connection between the connecting rod and the crank pin executes an elliptical path having a generally flat path portion as the piston approaches and leaves top dead centre position and wherein as the crank shaft rotates, no substantial movement of the piston occurs from top dead centre position whilst the point of connection between the connecting rod and the crank pin follows the flat path and as the connection leaves the flat path portion of the elliptical path, the angle the connecting rod makes with the plane passing through the rotary axis of the engine increases towards a maximum so that maximum power of the reciprocating piston in the power stroke is supplied to the crank while the angle approaches maximum angle to thereby increase the power delivered to the crank shaft from the piston.

In a still further embodiment of the invention, the piston is coupled to a guide roller, the rotary output member comprises a cam plate, the guide roller engaging the cam plate, the cam plate having a cam surface which is engaged by the roller, and the cam plate having a generally flat portion which prevents movement of the piston, and an inclined portion which, when engaged with the roller, results in the roller exerting a force which is at an angle to the tangent of the inclined profile so that force is imparted to the cam plate whilst maximum force is applied to the piston in the power stroke to thereby deliver maximum force to the rotary cam plate to rotate the cam plate.

The invention may also be said to reside in an engine including:
a rotary power member having a plurality of separated elements, each element being formed from a magnetically attractably material;
a permanent magnet arranged adjacent the member and overlapping the elements when the member rotates relative to the magnet;
at least one flux altering member for movement into and out of registry with the magnet in synchronisation with the rotation of the rotating power member; and
wherein magnetic attraction of the magnet draws the elements in turn towards the magnet, thereby causing rotation of the rotary power member, and whereupon as the respective elements arrive at the magnet, the flux altering members are moved into registry with the magnet to decrease the magnetic attraction between the elements and the magnet so that the rotary power member can continue to rotate to allow the respective elements to move away from the magnet after they pass the magnet, thereby providing a net output in the direction of rotation of the rotary power member.

Preferably, the engine includes a pair of said flux altering members, each movable into and out of registry with the magnet in synchronisation with the rotation of the rotary power member.

Preferably, the rotary power member comprises a disc and the elements comprise a plurality of teeth arranged at the periphery of the disc.

Preferably, each of the teeth includes a leading edge and a trailing edge, the leading edge and the trailing edge having a contoured shape which matches the periphery of the permanent magnet.

Preferably, each of the flux altering members comprises a disc having a plurality of arrays of ferromagnetic elements.

Preferably, the engine includes means for rotating the flux altering discs at twice the speed of the rotary power member, and wherein the flux altering discs have a diameter which is substantially half that of the rotary power member, so the periphery of the flux altering discs and the rotary power member travel at substantially the same speed.

Preferably, the rotary power member is mounted on an axle, the axle carrying a pinion, a ring gear in mesh with the pinion so that rotation of the rotary power member rotates the axle to in turn cause the pinion to rotate the ring gear, the ring gear being connected to the output for rotating the output to thereby provide rotary output power at the output.

Preferably, the ring gear is coupled to a mounting disc and the mounting disc carries a second and third ring gear, the flux altering discs, each being mounted on an axle, each axle having a pinion for engaging a respective one of the second and third ring gears, so that upon rotation of the disc, the second and third axles are rotated to thereby rotate the flux altering discs in synchronisation with the rotary power member to selectively bring the flux altering elements into and out of registry with the permanent magnet.

Preferably, the engine includes a plurality of banks of rotary power member assemblies, each assembly including a respective said permanent magnet and a respective said pair of flux altering members.

### BRIEF DESCRIPTION OF THE DRAWINGS

Preferred embodiments of the invention will be described, by way of example, with reference to the accompanying drawings in which:

FIG. 1 is a drawing illustrating the principle of the preferred embodiment of the present invention;

FIG. 2 is a view along the line II-II of FIG. 1;

FIG. 3 is a view illustrating the principle of the preferred embodiment of the invention in a second position;

FIG. 4 is a view along the line IV-IV of FIG. 3;

FIGS. 4A and 4B are diagrams further illustrating the operating principle of the preferred embodiment of the invention;

FIG. 5 is a plan view according to one embodiment of the invention;

FIG. 6 is a plan view according to a second embodiment of the invention;

FIG. 7 is a plan view of a component used in the embodiment of FIG. 6;

FIG. 8 is a diagram illustrating operation of the preferred embodiment of the invention;

FIG. 9 shows more detail of a first embodiment of the invention;

FIG. 10 is an exploded plan view of a crank shaft according to one embodiment of the invention;

FIG 10A is a view of part of the crankshaft of FIG. 10 in an assembled condition;

FIG. 11 is a view of part of the componentry of the crank shaft of FIG. 10;

FIG. 12 shows the path of movement of the big end of the crank shaft according to FIG. 10;

FIGS. 12A, 12B, 12C, 12D and 12E are a sequence of drawings showing operation of the embodiment of FIG. 5;

FIG. 13 is an end view of another embodiment of the invention;

FIG. 13A is a drawing showing the sequence of operation of the embodiment of FIG. 13;

FIG. 14 is an end view of a still further embodiment of the invention;

FIGS. 15, 16, 17 and 18 are diagrams illustrating the operation of a fourth embodiment of the invention;

FIG. 19 is a more detailed view of part of the embodiment shown in FIGS. 15 to 18;

FIG. 20 is a view of a further part used in the embodiment of FIGS. 15 to 18;

FIG. 21 shows an illustration of the relative disposition of the parts shown in FIGS. 19 and 20 in more detail;

FIG. 22 is a cross sectional view through an engine according to the fourth embodiment of the invention;

FIG. 23 is a detailed view of part of the embodiment of FIG. 22;

FIG. 24 is a view of a ring gear used in the embodiment of FIG. 22; and

FIG. 25 is a side view of the ring gear of FIG. 24.

### DETAILED DESCRIPTION OF THE PREFERRED EMBODIMENTS

FIGS. 1 to 4 show the principle of operation of the preferred embodiment of the present invention.

According to the preferred embodiment of the present invention, the engine includes a first permanent magnet 10 which is fixed in the head (not shown) of the engine.

A second permanent magnet 12 forms a piston of the engine to which an output, such as a crank shaft, is coupled for providing output rotary power. The second permanent magnet 12 reciprocates back and forward in the direction of double-headed arrow A in FIG. 1 relative to the first magnet 10.

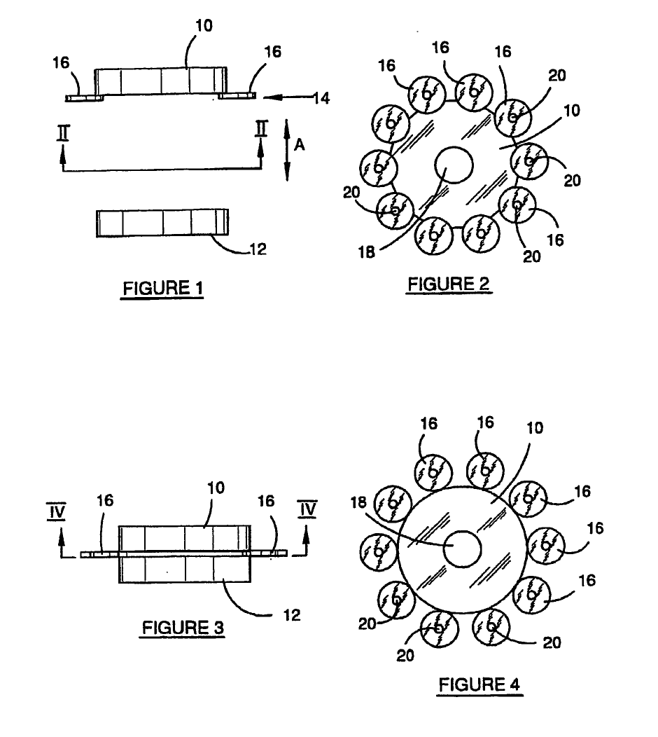

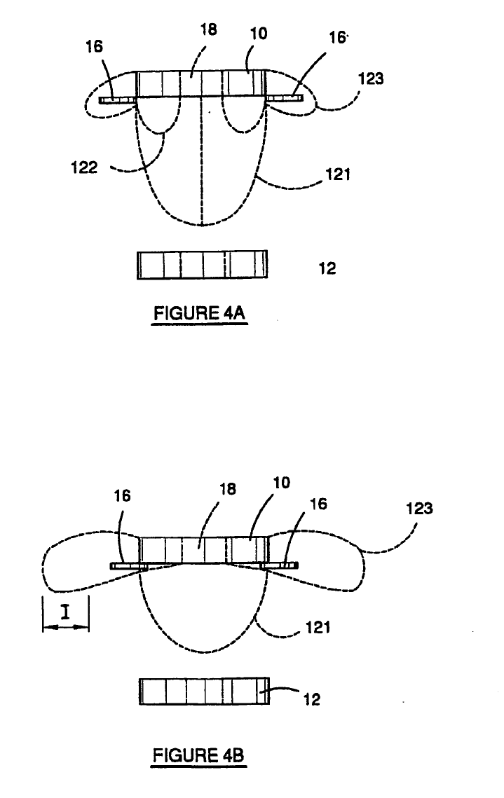

A flux altering mechanism 14 is provided for movement into and out of registry with the magnet 10 from a position adjacent the periphery of the magnet 10 (which is shown in FIGS. 3 and 4) to a position inwardly of the periphery of the magnet 10 as shown in FIGS. 1 and 2.

The mechanism 14 is formed from a plurality of circular discs 16 which will be termed valves for the reason previously explained. The valves 16 are arranged in a circular pattern, as clearly shown in FIGS. 2 and 4. The amount of movement of the valves 16 between the position shown in FIGS. 1 and 2, and 3 and 4 can be relatively small and in the order of a few millimetres. The magnets 10 and 12 can be provided with central holes 18 (shown in the magnet 10 in FIGS. 2 and 4), the purpose of which will be described hereinafter. The valves 16 are formed from magnetisable material such as iron or low grade mould steel, which are preferably of disc shape as shown in FIGS. 1 to 4 and which have a central hole 20.

FIG. 1 shows the magnet 12 (which forms a piston) in a bottom dead centre position spaced away from the magnet 10. In this figure, the magnet 12 is about to rise towards the piston 10 and the valves 16 are moved into a position in registry with the magnet 10 in which the valves are inward of the periphery of the magnet 10.

Movement of the valves into this position reduces the magnetic flux produced by the magnet 10 and to which the magnet 12 is exposed. The magnets 10 and 12 are arranged so that they have same poles facing one another. As is apparent in FIG. 1, the valves 16 are in close proximity to the magnet 10 and relocate a significant portion of the magnetic flux produced by the magnet 10 away from the magnet 12 when the valves 3 are in the inward position shown in FIG. 1. This will be explained in more detail hereinafter with reference to FIGS. 4A and 4B. Thus, the amount of magnetic flux which is exposed to the second magnet 12 is reduced, thereby reducing the repelling force between the magnets 10 and 12 and making it more easy for the magnet 12 to move towards the magnet 10. This effectively produces the compression stroke of the engine in which the piston formed by the magnet 12 moves towards the magnet 10.

When the piston 12 reaches the top dead centre position, as shown in FIG. 3, in which the magnet 12 is in close proximity to the magnet 10, the valves 16 are moved outwardly from the position shown in FIGS. 1 and 2 to the position shown in FIGS. 3 and 4 in which the valves 16 are outward of the periphery of the magnet 10. This restores the maximum magnetic flux of the magnet 10 which is exposed to the magnet 12 and the repelling force created by the same poles of the magnets 10 and 12 produces the power stroke to push the magnet 12 towards the bottom dead centre position shown in FIG. 1.

Because the magnetic flux exposed to the piston 12 is changed between the compression stroke shown in FIGS. 1 and 2 and the power stroke shown in FIGS. 3 and 4, with the flux effectively being increased in the power stroke by movement of the valve element 16 to the position shown in FIGS. 3 and 4, the compression stroke and power stroke of the magnet 12 produce a net output in the power stroke, thereby providing the output power from the engine. In other words, the engine produces a greater force in the power stroke in which the magnet 12 is forced away from the magnet 10 than required to overcome the magnetic repulsion in the compression stroke in which the magnet 12 moves towards the magnet 10.

Preferably the magnets 10 and 12 are identical in dimensions and the holes 18 have a diameter of approximately ⅓ of the outside diameter of the magnets 10 and 12. The magnets 10 and 12 preferably have a thickness of 22% of their outside diameter. The valves 16 have a diameter of approximately 33% of the outside diameter of the magnets 10 and 12 and the hole 20 in the valves 16 is approximately 33% of the outside diameter of the valves 16. The thickness of the valves 16 is approximately 10% of the outside diameter of the valves 16.

Preferably the valves 16 are of a number and arranged so that they contact one another when in the closed position shown in FIGS. 1 and 2. The valves in this position each encroach onto the surface of the magnet 10 by approximately 20% of the radius of the magnet 10. When the valves are in the open position shown in FIGS. 3 and 4, they are generally level with the outer periphery of the magnet 10.

The valves 16 are preferably circular in plan view with the hole 20 in their centre, because such a configuration can produce as high as 30% more output from the engine compared with valves 16 of other shapes such as square or triangular. However, depending on the gauss rating of the magnets 10 and 12, other shapes could be used to provide maximum output power. The circular shape causes a phenomenon that achieves more positive results in a power stroke, and also more positive outcome occurs in the differential between the inward and outward action of the valves.

The manner in which the magnetic flux produced by the magnet 10 is relocateed away from the magnet 12 is explained in more detail with reference to FIGS. 4A and 4B.

In FIG. 4A, which illustrates the situation when the valves 16 are moved out of registry with the magnet 10, and the magnet 12 is undergoing the compression stroke, it can be seen that the magnetic flux produced by the magnet 10 is in the form of a dome 121. It should be noted that because of the inclusion of the hole 18, the nature of the flux produced by the magnet is somewhat different to a circular magnet which does not have the hole 18. The dome 121 is slightly smaller than would be the case if the hole 18 was not present. Thus, the inclusion of the hole 18 slightly reduces the flux aura 121 in size and strength. A secondary aura is formed as a donut shape 122 around the hole 18 between the periphery of the hole 18 and the outer periphery of the magnet 10.

In the power stroke, the secondary aura 122 creates a phenomenon which causes substantially more output on a magnet with a hole as opposed to a same gauss rating non-hole magnet, even though in the power stroke there is 10% less surface area exposed on each magnet due to the hole leaving less magnet surface area on the magnet 10. The valves 16 and the magnet 10 also produce a radial aura 123.

As the magnet 12 moves up towards the magnet 10 in the compression stroke, as is illustrated by FIG. 4B, the valves 16 are moved to the position where they encroach on part of the magnet 10, as has been previously explained. The movement of the valve 16 causes a relocateation of the magnetic flux which produced the donut shaped aura 122 away from the magnet 12 and generally into the aura 123 so as to thereby increase the size of the aura 123 beyond its original width. The size of the aura 121 is also further decreased. Thus, much of the magnetic flux produced by the magnet 10 is relocateed away from the direct vicinity of the magnet 12 to a more radial or peripheral position outside the magnets 10 and 12, and therefore that aura has less repelling effect on the magnet 12 compared to that which existed when the valves 16 were in their outward position shown in FIG. 4A. The additional distance by which the aura 123 has been increased is shown by arrow I in FIG. 4B. Thus, according to the preferred embodiments of the invention, use of the element 16 distances the flux well away from the active area of the magnet 12 when in the compression stroke, thereby allowing a significantly reduced effort in the compression stroke. As it is noted with reference to FIG. 4A, when the valves 16 are moved to their outward position, the original configuration of the flux aura is restored so that the flux aura is effectively relocated back to its original position thereby producing the greater magnetic repulsion to force the magnet 12 away from the magnet 10 and produce the power stroke. The increase in power supplied during the power stroke compared to that which is required to push the magnets together when in the compression stroke is thereby performed by relocating the magnetic flux from a position where it acts on the magnet 12, as shown in FIG. 4A, to a position where it has significantly less repulsion force on the magnet 12, as shown in FIG. 4B, thereby producing the power differential in the power stroke compared to that which is required to return the magnets to their point of minimum separation during the compression stroke, and thereby providing the power gain from the engine.

In the preferred embodiment of the invention, the discs 16 can contact the magnet 10 during the movement into their positions shown in FIG. 4B, and effectively slide on the magnets 10. As is apparent from FIG. 4B, when the valves 16 are in their inward position, they effectively tap into the aura 122, thereby drawing the aura 122 away from the position shown in FIG. 4A into the aura 123 as shown in FIG. 4B. The large percentage of the flux above magnet 10 which is located in aura 122 is a phenomenon created by the hole in the magnet as described earlier, this powerful aura of flux now being positioned to the outer area of the magnet 10 allows the valves 16, with their relatively short inward movement during compression mode, to have the ability to tap into this concentrated flux aura 122 and virtually transport all the effective flux in it to an outer location well away from the active area of the magnets 10 and 12 in compression mode, as shown in the now extended aura 123 by the arrow I in FIG. 4B.

The outer diameter of the valves is also an important factor as it is used to distribute the mass in the valves away from the magnet 10 by a distance so the valves 16 do not absorb too much flux away from the magnets 10 and 12 when in the power stroke. The outside diameter should not be too large because the valves remain at the perimeter of the magnet 16 and in the magnetic flux of the magnet 16, and it takes a moderate force to retract the valves from the compression stroke position shown in FIGS. 3 and 4 back to the position shown in FIGS. 1 and 2. If the valves 16 extend beyond the magnetic flux of the valve, additional force is required to retract the valves into the position shown in FIG. 1, which reduces the output of the engine. The mass of the valves 16 should be such that the valves will absorb a significant quantity of the flux away from the first magnet 10 when the valves 16 are positioned in the position shown in FIGS. 1 and 2. Unnecessary placement of too much mass in the valves 16 in close proximity to the magnets can significantly reduce the gauss rating in the magnets by absorbing further flux in the power stroke, whilst having little, if any, effect on the compression stroke, which means a smaller differential and, in turn, a lower engine output. A circular valve has the best characteristics to distribute the mass where required in the operation of the engine.

The hole 20 in the valves 16 does not create any particular phenomena. The hole merely adjusts the distribution and quantity of the mass in the valves 16.

The thickness of the valves 16 is another factor which should be taken into account when designing the valves 16 because the thickness of the valves 16 will determine the closest distance the magnets 10 and 12 are able to be brought together. This distance should be kept to a minimum because the major force produced is achieved when the magnets are as close as possible to each other at the start of the power stroke shown in FIGS. 3 and 4.

The valves 3 are preferably arranged in pairs, as will be described in more detail hereinafter, because the negative force required to retract the valves at the end of each compression stroke is reduced by about 30% compared to situations when each valve 16 is retracted individually. The positioning of the valves 16 in the compression stroke create the phenomenon which produces the power output and comprises three factors which create an exponential effect throughout the compression stroke. As previously explained, when the valves 16 are moved to the position shown in FIGS. 1 and 2, the valves 16 encroach an approximate distance of 20% of the radius of the magnet 10.

The first positive effect is the absorbing of the magnetic flux present on the magnet surface beneath the area where the valves 16 have overlapped the magnet 10. The flux beneath the valves 16 is virtually all absorbed by the valves and then transferred through the valves 16. The valves 16 in turn become magnetised but the magnetism in the valves has no further effect on the action between the magnets 10 and 12 in the compression stroke, because the magnetisation of the magnets 16 does not present an opposite pole to the magnet 12. Effectively, approximately 30% of the surface of the magnet 10 has been totally neutralised from having any opposing effect to the approaching magnet 12 in the compression mode. The end result is a smaller opposing surface area on the head magnet 10 to the approaching piston 12.

The second positive effect is that because the magnet 10 has a diameter reduced by the intrusion of the valves 16, it effectively provides a smaller magnet. Accordingly, the height of the magnetic field of the magnet 10 is reduced. The result being a lesser average opposing force in the height of the magnetic flux against the approaching piston 12.

The third positive effect is created by the ferrous valve material replacing the 30% of the surface of the magnet 10. This not only neutralises the effect of the magnetic flux on that area of the magnet 10, but also it replaces the area with a ferrous mass that the approaching piston magnet is significantly attracted to, in turn, further countering the opposing magnetic forces between the magnets 10 and 12.

The above three factors create a phenomenon which reduces the average force in the compression stroke down to approximately 30% of the power stroke.

It should also be noted that the inward horizontal movement of the valves 16 from the position shown in FIGS. 3 and 4 to the position shown in FIGS. 1 and 2, occurs while the magnet 12 is at bottom dead centre (ie. furthest away from the magnet 10). This valve movement occurs under an attraction by the magnet 10 against the ferrous metal valves 16 which results in a positive force which can be harnessed as part of the overall output of the engine. The outward movement of the valve occurs at top dead centre, where the magnets 10 and 12 are at their closest. This retraction of the valves occurs under an opposing force by the pair of magnets acting on the ferrous metal valves. Due to the pair of magnets in this action being in close vicinity to each other, the outward force required to remove the valves is higher than the single magnet present on the inward travel referred to above. The differential between the inward and outward movement results in the outward movement requiring approximately 46% more force than the inward movement. The differential in energy required to operate the valves being a negative outcome, equates to 25% of the output produced by the power stroke.

Preferably the magnets have a circular form as previously described, so that the effect by the valves on the surface of the magnets is even. The holes 18 in the magnets 10 and 12 have two significant characteristics. The first is the presence of the hole in most magnets prior to the valves 16 being introduced between the magnets, even though the surface area is reduced, creates the phenomenon which the opposing force between two like magnetic poles is significantly greater than not having a hole in the magnets. This characteristic cannot be classed as contributing to the exponential effect of the magnetic engine, but only enhances the fact that less magnets and valves 16 are required for particular application to provide a given output requirement.

The basic difference of a magnet having a hole 18 over a magnet not having the hole equates to approximately 18% increase in the final output of the engine, due to the larger gauss rating of a holed magnet.

The hole becomes more significant when the interaction of the valves 16 is considered. The combination of the hole in the magnets 10 and 12 and the presence of the valves 16 provides a fourth significant phenomena which is created and which increases exponentially of the output of the engine. The presence of the hole does not effect the compression force but the output is increased significantly in the power stroke, resulting in a differential gain of the holed magnets over non-holed magnets by about 25%. The final output of the engine of a given magnet size, due solely to the holes, is approximately 43% more output. The phenomena which causes this advantage is due to the very prominent donut-shaped magnetic flux field which is created around the magnetic between the outer edges of the magnet and the edges of the holes 18 in the magnet. This flux field is in addition to the dome-shaped flux field over the entire magnet surface which both holed and non-holed magnets possess.

The magnets and the power stroke have a constant opposing force right through the power stroke of the engine. The magnets in the compression stroke, although far less, also have an opposing force from bottom dead centre until the magnet 12 reaches approximately 12% of the stroke from top dead centre, where a phenomenon occurs, which starts to lower the compression force rather than the obvious expected further increase. Up until this 12% point from top dead centre, the opposing force between the piston magnet 12 and the effectively reduced size of the magnet 10 in the compression mode, have been only counted by the attraction of the piston magnet 12 by the valves 16 which are now located between the magnets 10 and 12. However, as the magnets reach the 12% from top dead centre, the valves 16 come under influence of a smaller flux which extends outward from the perimeter of the magnet 12. The exposed area of the valves 16 outside the perimeters of the magnets 10 and 12 is then attracted to that magnetic flux. This additional attraction further counters the opposing force between the two magnets 10 and 12, and the opposing force rapidly reduces until approximately 6% of the stroke before top dead centre. The opposing force then reverses to an attraction between the two magnets 10 and 12, which contributes to the output of the engine.

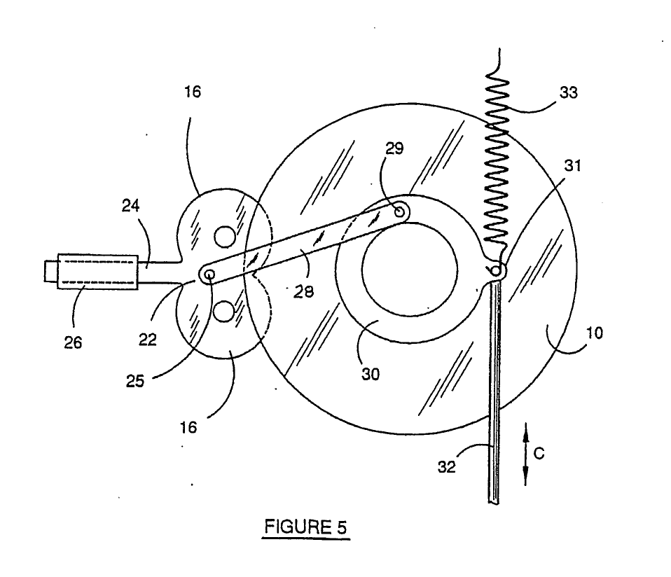

FIG. 5 shows one embodiment of how the valves 16 are moved inwardly and outwardly between the position shown in FIGS. 2 and 4.

With reference to FIG. 5, as has been previously explained, the magnet 10 is mounted in the head (not shown) of the engine, and the head also supports the mechanism for operating the movement of the valves 16. In this embodiment, the valves 16 are arranged in pairs and only one pair is shown for ease of illustration. The valves 16 are connected together by a web 22 which carries a stem 24. The stem 24 is received in a sleeve 26 which is fixed in the head of the engine. The web 22 is also pivotally connected by a pivot pin 25 to a rod 28. The other end of the rod 28 is pivotally connected by a pivot pin 29 to a rotating disc 30. The disc 30 can be mounted in the head for rotation. The rotatable disc 30 has a lug 31 which is pivotally connected to a push rod 32. The lug 31 is also connected to a spring 33. The rod 32 is actuated by rotation of the crank shaft (not shown) of the engine so that it reciprocates back and forward in the direction of double-headed arrow C in FIG. 5 in synchronism with rotation of the crank shaft. When the rod 32 moves upwardly in FIG. 5, the disc 30 is rotated in a counter-clockwise direction which pushes the rod 28 to the left in FIG. 5 so that the stem 24 slides in sleeve 26. This moves the two valves 16 outwardly of the magnet 10 so that they are just level with the periphery of the magnet 10 as shown in FIG. 4. When the rod 32 moves downwardly, the rod 28 is moved to the right in FIG. 5, thereby pulling the valves 16 inwardly to the position shown in FIG. 5 and also FIGS. 1 and 2. Thus, as the engine cycles, the rod 32 is reciprocated back and forward in the direction of double-headed arrow C to push the valves 16 outwardly and then pull the valves 16 back inwardly between the positions shown in FIGS. 2 and 4.

As will be apparent from the above description, each pair of valves 16 is provided with its own rod 28, stem 24 and sleeve 26.

As is also explained above, the magnetic attraction of the magnets 10 and 12 tends to pull the valves 16 inwardly because of the magnetic attraction of those magnets and the ferrous material from which the valves 16 are formed. A spring 33 is provided for biasing the disc 30 to counter the natural attraction the magnets 10 and 12 exert over the valves 16. This balances the magnetic force so that the valves 16 are effectively free-floating without any force upon them in the upward movement so the valves 16 can moved upon reciprocating movement of the rod 32 very easily. The energy which would otherwise retract the valves 16 inwardly towards the magnets 10 and 12 is therefore stored in the spring 33 and this energy assists in the movement of the valves 16 to the outermost position shown in FIG. 4. The energy stored in the spring 33 accounts for approximately 55% of the energy required to move the valves 16 to the outer position shown in FIG. 4 and the short fall in energy is supplied from the engine.

The reciprocating movement of the rod 32 can be supplied from a cam (not shown) which operates from the crank shaft of the engine or by any other suitable linkage from the crank shaft of the engine.

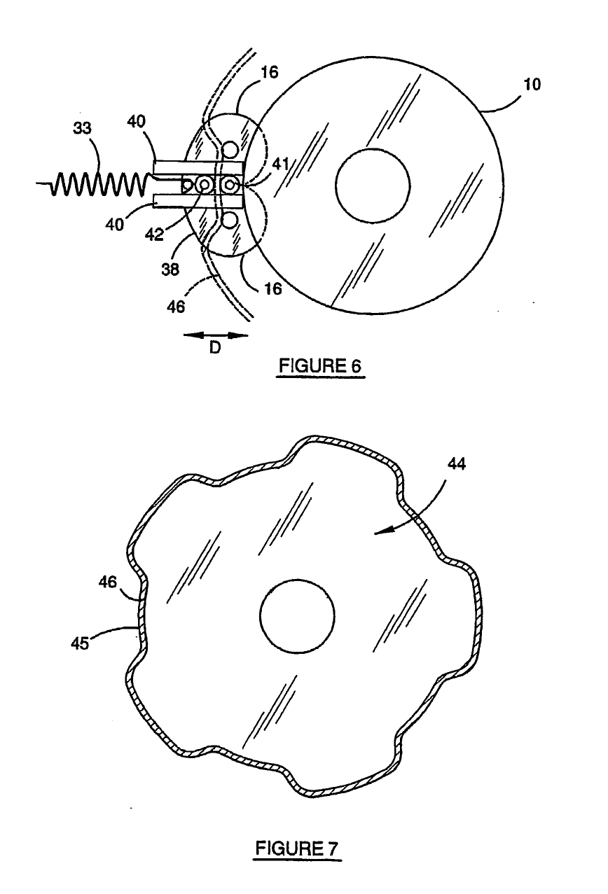

FIG. 6 shows a further embodiment of the invention. In this embodiment, each pair of valves 16 is connected by a web 38 as in the previous embodiment. However, in this embodiment, a pair of guide rails 40 are provided which receive rollers 41 and 42 which are mounted on the valves so that the rollers, and therefore the web 38 and valves 16, can move back and forward in the direction of double-headed arrow D in FIG. 6, relative to the guide rails 40.

A cam plate 44 shown in FIG. 7 is provided for moving the valves 16 back and forward in the direction of double-headed arrow D. The cam plate 44 has a peripheral cam edge 45 which is provided with an upstanding flange 46. The upstanding flange 46 is received between the rollers 41 and 42 as shown by the dotted lines in FIG. 6. The cam plate 44 is mounted for rotation in synchronism with the rotation of the crank shaft of the engine so that as the cam plate 44 rotates, the flange 46 effectively pushes the rollers 41 and 42 back and forward as the contoured edge 45 of the cam plate 44 moves between the rollers during rotation of the cam plate 44. Thus, the valves 16 are reciprocated back and forward in the direction of double-headed arrow D. A spring 33 is connected to the web 42 for countering the attraction the magnet 10 exerts over the valves 16 and which functions in exactly the same manner as the spring 33 described with reference to FIG. 5. Thus, once again, the spring 33 can supply some of the energy for moving the valves 16 as in the previous embodiment.

The advantage of the configuration shown in FIG. 6 over that shown in FIG. 5 is that FIG. 6 merely rotates the cam 44 in one direction to effect the reciprocating movement of the valves 16, whereas FIG. 5 requires reciprocating movement of the rod 32 in order to produce the reciprocating movement of the valves 16. Thus, in the embodiment of FIG. 6, less energy loss occurs. The embodiment of FIG. 6 is more suited to a high-revving permanent running application where maximum output is the target.

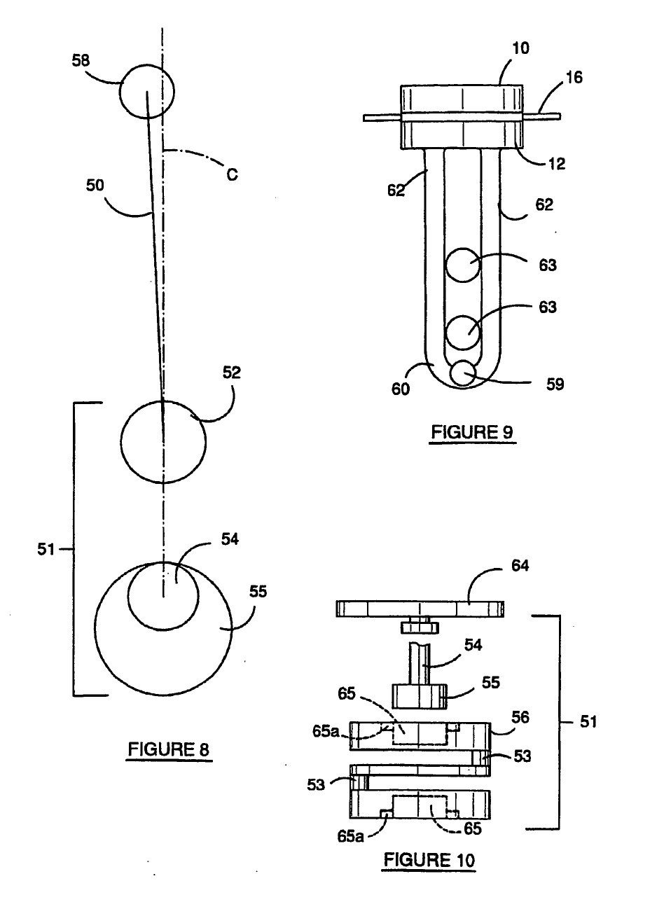

FIGS. 8 to 12 show more detail of a first embodiment of an engine embodying the above principles.

The magnetic engines of the preferred embodiments will produce in each revolution an additional unit of energy similar to a combustion engine, but unlike a combustion engine, there is no limitation like speed at which the flame travels, pneumatic expansion, nor induction of elements. Therefore, engines according to the preferred embodiments of this invention are only restricted in revs by the strength of the mechanical components under centrifugal force, lubrication breakdown, etc, so as high a revs as possible is the target to achieve maximum efficiency until the production costs, maintenance and longevity ratio outweighs a high rev limit. Furthermore, there is one major factor that severely restricts the rev limit on the use of a conventional piston crank configuration. When the piston reaches each end of its stroke, it has to have ultimate valve movement take place, prior to any change in direction as the main output is produced at and near top dead centre. In a high revving engine of similar dimension to an average car engine, it is not mechanically possible to open and close the valves 16 in less than 35° of rotation for each direction of valve movement. To overcome this problem, the engines of the preferred embodiment require a dwell at top dead centre and bottom dead centre of 35° to allow full movement of the valves 16 to occur prior to any or only minimal stroke reversal from each end of the cycle. The arrangement employed in the present invention to achieve this result could also be employed in conventional internal combustion engines to result in much more of the power stroke of the engines occurring when the connecting rod of the engine is more appropriately aligned with respect to the crank shaft of the engine.

This also would reduce the steep cam ramps on high revving engines with the longer dwell and allow time for more complete burn of mixture for more power at the start of the power stroke.

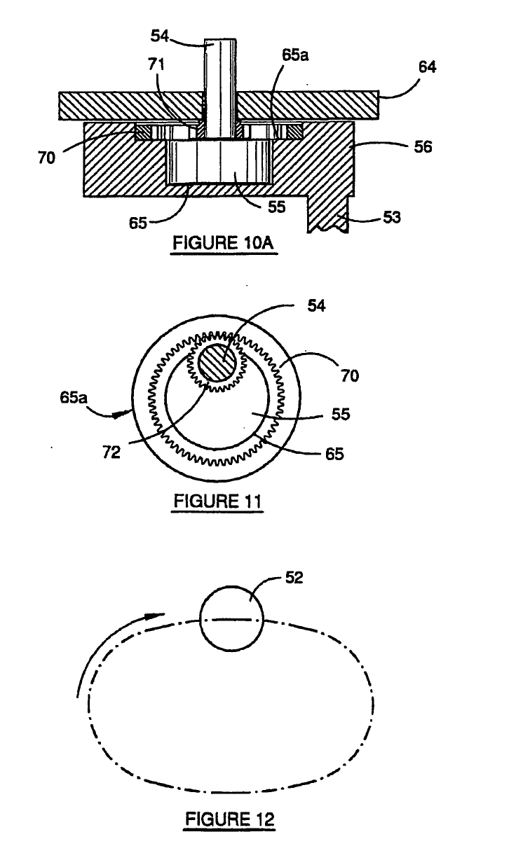

With reference to FIGS. 8 to 12, the engine according to this embodiment has four pairs of magnets 10 and 12 in twin sets of opposing banks. FIG. 8 shows an end view in schematic form of the engine in top dead centre position in which connecting rod 50 is connected to big end 52 of the engine, which in turn is mounted for rotation on one of the crank pins 53 (see FIG. 10) of the engine. Reference numeral 54 represents the main axel of the crank shaft of the engine and a circular cam 55 is connected onto the main axel 54 and forms a primary crank. The cam 55 is received inside secondary crank assembly 56, as will be described in more detail hereinafter.

As is shown in FIG. 8, con rod bearing 58 attaches to gudgeon pin 59 (see FIG. 9) which in turn couples to second magnet 12 which forms the piston of the engine. The gudgeon pin 59 is formed in a U-shaped transition section 60 between a pair of guide rails 62 fixed to the magnet 12. The guide rails 12 guide reciprocating movement of the magnet 12 via bearings 63.

As is shown in FIG. 8, the gudgeon pin 59 which is connected to the bearing 58 is offset to the left of centre line C of the crank assembly 51 when the magnet 12 is in the top dead centre position, which is offset by 2.6% of the crank stroke. As will be described hereinafter, the engine crank assembly 51 produces an elliptical path for the big end 52 due to the double crank action.

As shown in FIGS. 10 and 10A, the crank 51 has an end plate 64 at each end (only one shown). The secondary crank assemblies 56 are provided with recesses 65 and the cam 55 of each of the main axels 54 (only one shown in FIG. 10) locates in each of the recesses 65. Rotary power will be taken off from the main axels 54 of the crank assembly 51.

The recesses 65 have an enlarged outer diameter portion 65a. A ring gear 70 is located in the enlarged diameter portion 65a and casing 64 carries a stem 71 through which axel 19 is journaled and the stem 71 is provided with a ring gear 72 which, as is best shown in FIG. 11, is eccentrically arranged with respect to the gear 70.

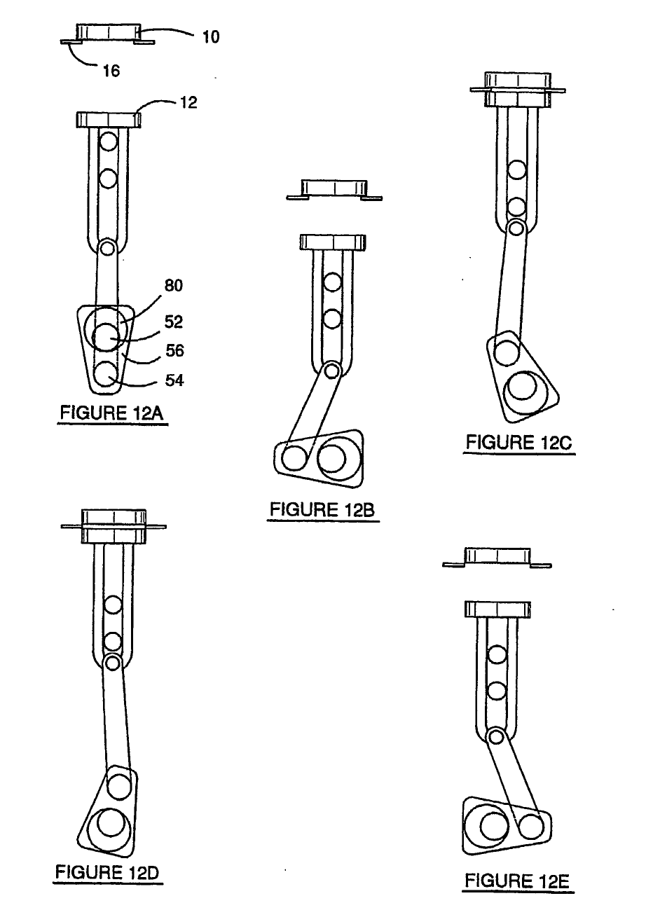

As previously mentioned, the big end 52 of each con rod 50 mounted on a respective one of the crank pins 53 and which are 180° out of phase with one another as shown in FIG. 10 when the crank rotates, a double orbit type rotation is produced by the meshing engagement between the gears 70 and 72. The gears 70 and 72 have a gear ratio of 1.5 to 1 which causes the axel 54 and its attached primary crank cam 55 to turn three revolutions to every one revolution of the secondary crank assembly 56. The interaction of the double crank configuration causes the crank assembly shown in FIG. 6, to not only rotate but during each cycle, the big end 18 follows a constant elliptical path as shown in FIG. 12.

This elliptical path produces the dwell of about 37° which is required to operate the engine and which is shown by the relatively flat upper and lower portions of the elliptical path shown in FIG. 12. The 37° of flat dwell is divided into 22° before top dead centre or bottom dead centre, as the case may be, and 150° after top dead centre and bottom dead centre, as the case may be. This flat dwell enables full movement of the valves 16 from the position shown in FIGS. 1 and 2, to the position shown in FIGS. 3 and 4, before the piston 12 attempts to move away or towards the piston 10. This results in the magnetic flux being reduced in a manner previously described before the piston 12 commences movement towards the piston 10 in the compression stroke and, full retraction of the valves 16 back the position shown in FIGS. 3 and 4 before the engine commences the power stroke in which the magnet 12 moves away from the magnet 10. Thus, this results in the full magnetic power of the magnet 10 being available to push the magnet 12 away from the magnet 10 during the power stroke and for the power of the magnet to be fully reduced before the compression stroke commences. If sufficient dwell time is not provided to enable the valves 16 to move into and out of their operating positions before the piston 12 commences movement away from or towards the magnet 10, then much of the power of the power stroke will be lost and a greater force in the compression stroke will be required, thereby greatly reducing the output power available from the engine.

The engine of FIGS. 8 to 12 operates by the connecting rod 50 pushing the second crank 56 in the power stroke of the piston 12. As previously described, this causes the big end 52 which is connected on crank pin 53 to follow the elliptical path described with reference to FIG. 12. Rotation of the secondary crank 56 is imparted to the primary crank 55 by the meshing of the gears 70 and 72. The meshing point of the gears 70 and 72 continually changes position in view of the eccentric arrangement of the gear 72 with respect to the gear 70, in relation to the position of the big end 52 due to the 3 to 1 rotation ratio of the secondary crank 56 relative to the faster rotating primary crank 55. The force acting on the secondary crank 56 is the prime drive action that turns the axel 54, but during that action, the force next transfers to act against the primary crank 55, then rotate the axel 54. The primary crank 55 in half of its rotation, is either in the position of effectively having a direct push on its peak side by the big end 52, and on the other half of rotation, the peak side is under a counter-levered push, continually using the contact point of the gears 70 and 72 as the hinging point. As explained above, the reason for the primary crank 55 is to produce the elliptical path which is followed by the big end 52, which in turn produces the 37° of flat dwell at the top and bottom of the stroke of the magnet 12.

FIGS. 12A to 12E show a sequence of drawings illustrating the rotation of the cam of this embodiment.

The primary crank 80 can be seen inside secondary crank 56 both relating in a clockwise direction. Primary crank 80 rotates faster than secondary crank 56, due to the 1.5 to 1 ratio gears 70 and 72, thereby creating the elliptical path of big end 52. FIG. 12A shows the big end 54 at bottom dead centre with valves 16 at half way towards their closing position because the big end 52 is approximately half way through the 370 dwell.

FIG. 12B shows valves 16 are fully inward and the compression stroke has commenced. FIG. 12C shows the pitch line through the big end 54 and axle 52 has reached 23° before top dead centre, this is the point where the piston magnet 12 has reached its closest point to head magnet 10 which also is the start of the dwell. At this point the valves 16 start to retract. FIG. 12D shows the pitch line between big end 54 and axle 52 is at 15° passed top dead centre, the end of the dwell, and the valves are fully retracted ready for piston magnet 12 to start the power stroke.

The arrangement of the present embodiment also has the significant advantage of producing the virtually flat big end path at each end of the stroke through the 37° of crank rotation as described above. This embodiment has a long dwell created by a long flat path from top dead centre onwards where the engine rotates without any downward piston movement. Therefore, significant degrees of rotation is achieved at the maximum force when eventual downward piston movement occurs, which will be far slower as a ratio of rotation to downward piston travel, to that of a conventional crank assembly. While the dwell at the sustained high force is occurring, the angle of push of the connecting rod 50 between the relation of the big end elliptical path shown in FIG. 12 and the engine axel centre, is at a far more positive and faster increasing angle of push during this dwell than a conventional crank assembly at the same degrees of rotation. The combination of these two factors in the engine at the high end force far exceeds what occurs at the high end force in a conventional crank configuration. In turn, the output power produced by the engine is increased.

In more detail, the big end, according to the preferred embodiment of the invention, moves from top dead centre from 20° past top dead centre with virtually no downward piston movement (in reality a movement of about 1.3% of the stroke of the magnet 12 occurs) during that rotation. At 20° of rotation, the angle of push between the big end 52, which is following the elliptical path, and the axel 54 has reached about 40°. At this point, the force the magnet 10 exerts on the magnet 12 is still at a maximum because the magnets 10 and 12 are still in the position shown in FIG. 9 (ie. their closest position). A few degrees further on, the angle of push by the connecting rod 50 reaches the maximum angle of push, ie. 90° between the relationship to the path of the big end 18 and the engine axel 54. At this point, the magnet 12 has only moved approximately 9% of its downward travel and the force is still at a high of approximately 50%. If this is compared to a conventional piston crank assembly, which does not reach its 90° angle of push until 60° of rotation at which the piston has moved 33% of its stroke, it can be seen that the force acting on the piston at that time is down to below 20% of the maximum force. Thus, the preferred embodiment of the invention produces a power stroke which begins to occur when the angle between the connecting rod 50 and the axel 54 is approaching a maximum at which maximum force can be delivered to rotate the crank.

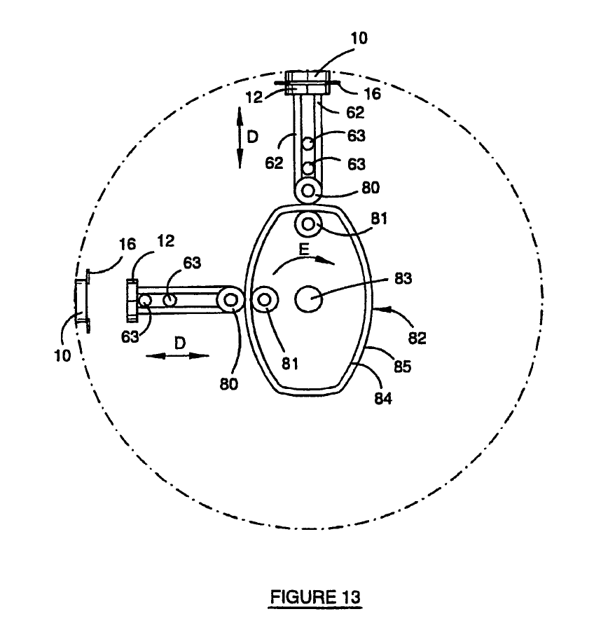

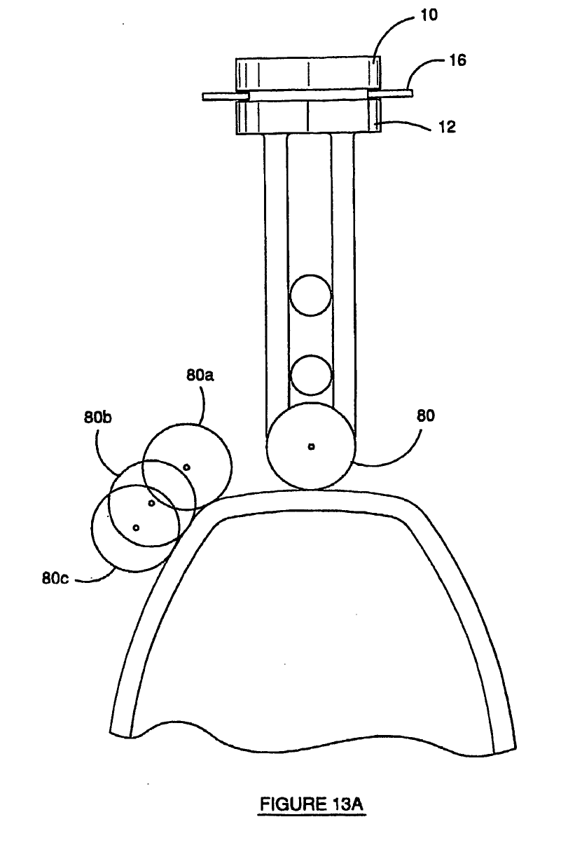

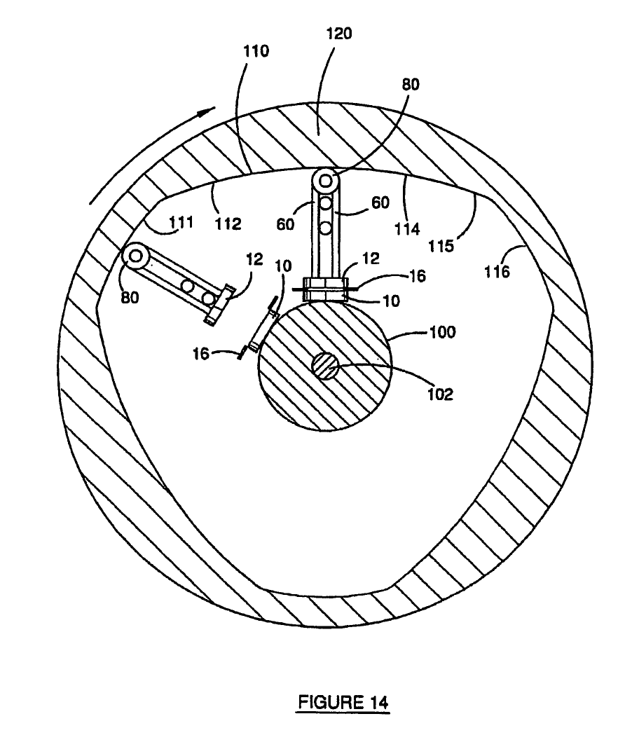

FIG. 13 shows a still further embodiment of the invention in which like reference numerals indicate like parts to those previously described.

In this embodiment, the connecting rod 50 is replaced by a roller 80 which connects onto gudgeon pin 59 (as shown with reference to FIG. 9) and a second cooperating roller 81.

It should be noted in FIG. 13 that two sets of magnets 10 and 12 are shown. One in the top dead centre position and the other in the bottom dead centre position. Additional sets of magnets 10 and 12 could also be included. In the arrangement shown, four sets of magnets 10 and 12 could be provided, with the other two being opposite the two shown in FIG. 13. Additional sets could be interposed between those four if desired.

A cam plate 82 is connected onto the rotary axis 83 of the engine to provide output rotary power. The plate 82 has an edge profile 85 with an upstanding rim 84 which is received between the rollers 80 and 81. As the pistons 12 move in reciprocating motion in the direction of double-headed arrow D, the cam plate 82 will be rotated, for example in the direction of arrow E, to provide output rotary power.

In this embodiment two cycles of the magnet 12 are required for each revolution of the cam plate 82. In the compression stroke in the direction of arrow E, the lower side of cam 82 pushes up against roller 80, lifting magnet 12 to top dead centre at cam peak. The valves are then retracted as the roller 80 rolls of the left side of the cam peak. The force generated by the downward movement of piston 12 rotates cam 82.

As is apparent from the configuration of the flange 84, which has flat portions which are engaged by the rollers 80 when in the top dead centre and bottom dead centre position, the flat dwell of 35° is again provided to enable the valves 16 to move to their operating positions before the compression stroke or power stroke of the magnet 12 commences.

This embodiment of the invention provides a mechanical advantage. This advantage is achieved over a conventional crank configuration. The mechanical actions operating in this embodiment create two factors which, combined, create a significant increase in output above what is achievable in a conventional crank configuration.

The advantage above a conventional crank configuration is caused by a prolonged distance of rotation of the cam 82 pitch circle while at a higher average level of force.

The factors which cause the mechanical advantage are demonstrated in FIG. 13A. In this diagram, the top section of the cam 82 and one actuator assembly with roller 80 is shown central above the top dead centre. There are three silhouettes of roller 80 identified as 80a, 80a and 80c, they are positioned at various degrees to the left of roller 80. These three silhouettes represent the downward movement of roller 80 in relationship to the cam 82, while the cam rotates passed the vertical position of the actuator as shown in this diagram.

The first factor is that the maximum mechanical angle of push by bearing 80 against cam 82 can be achieved soon after top dead centre. An example is shown in FIG. 13A, 80a is at the start of downward travel, arrow F indicates that 10° rotation of cam 82 has taken place between roller 80a and 80b and arrow G indicates an angle of push off which has been achieved, this is approximately 50% of the ultimate mechanical angle compared to a conventional crank which only achieves around 15° at that point.

This advantage of three to one over a conventional crank is still at approximately two to one when the main force has reduced to 25%, therefore achieving a major advantage throughout the high force range of power stroke.

The second factor is that the pistons downward travel in this embodiment compared to a conventional crank, is greatly retarded when comparing it to the rotation travel the pitch of cam 82, the pitch being the contact point of the roller 80 and outer surface of cam 82, and that pitch being the equivalent of the big end pitch circle of a conventional crank. In a conventional piston crank relationship, the piston moves downward approximately one and a third to one of big end travel around the pitch circle. In this embodiment, the piston in the higher range starting from top dead centre, its relationship is reverse, the piston can move less than half the cam 82 pitch circle. This is indicated in FIG. 13A.

Arrow H indicates the pitch circle line of top dead centre, arrow I indicates the vertical distance of travel piston 12 has moved roller 80 downward from 80d to 80c position. Arrow J indicates the distance roller 80 has travelled around the cam 82, pitch circle. In this diagram piston has moved downward 2½mm and roller 80 has moved 6 mm.

The combination of the two above described factors occurring in the higher range of force creates the mechanical advantage over a conventional crank configuration. There is only one sacrifice in the action of this embodiment in FIG. 13, the inward movement of roller 80 reduces the leverage distance from axle centre 83, this is only a minor reduction, where over the effective average force range can be as little as 10% reduction compared to the approximate doubling of force angle and simultaneously having in the deterioration speed of piston 12 force.

FIG. 14 shows a still further embodiment of the invention which is somewhat similar to the embodiment described with reference to FIG. 13. However, in this embodiment, the fixed magnets 10 are located radially inwardly and are mounted on rotating frame 100 which in turn is mounted to fixed axel 102.

Rollers 80 which mount on gudgeon pins 56 engage flange 110 of cam plate 120. The roller 80 rolls on surface portion 111 of the cam surface 110 and then up ramp portion 112 in compression until top dead centre is reached. The magnets 10 and 12 are held together as the roller 80 moves along plateau portion 114, creating the cam dwell for the valves 16 to open and close in the manner previously described. Full power stroke is then produced during the down ramp portion 115 by the stored centrifugal force from the compression combined with the force of the moving piston 12 in the power stroke mode of the engine, until the roller 80 engages cam portion 116, which again provides a dwell of 35°. The sequence of operations then repeat themselves. In the embodiments shown, the cam plate 120 is provided with three sets of cam surface portions 111, 112, 114, 115 and 116. Whilst only two sets of magnets 10 and 12 have been shown, additional sets can obviously be included in this embodiment as in the previous embodiment.

The cam track of this embodiment produces one revolution of the frame 100 and output axel 102 for three cycles of each of the magnetic pistons 12. The operation of this embodiment is unlike the embodiment of FIG. 13 as it provides no gain through a mechanical advantage and the output directly relates to the output of the magnets 10 and 12.

The embodiment of FIG. 14 provides an engine with a lower rev range capability, due to the output shaft revolving only once for each three cycles of the magnetic piston 12. This low rev range accompanied by high torque would suit applications of low rev engines, therefore either not needing a gearbox of, if so, a less number of gear sets, thereby making the engine more cost effective than those of the previous embodiments. This embodiment would suit applications of intermittent use as, because of its design, it would be made far cheaper, to suit a shorter working life application than the engines of the previous embodiments. In this embodiment, the entire internal area of the engine, including the magnets 10 and 12 revolve with the axel. Apart from the head, all that remains of the assemblies of the magnets 10 and 12 run around the outer stationary cam plate 120 or under the more desired compression, for reciprocating components. This is due to the constant centrifugal force acting on the magnets 12. This embodiment therefore only requires a light central rotating frame 100 to locate the magnets 10, 12 against and in line with the surface of the cam plate 110 which takes most of the load. The components, due to most of the reciprocating parts being always under compression, can be lighter and made of cheap basic non-ferrous materials which are required in the close vicinity to the magnets 10 and 12, no fly wheel is required as the whole rotating assembly acts as a fly wheel. No return spring assembly or twin big end roller assembly, as in the embodiment of FIG. 13, is required to arrest the change in direction of the piston assemblies at top dead centre or bottom dead centre because centrifugal force will at all times keep the magnet assemblies pushed against the outer surface of the cam plate 110.

This embodiment also enables maximum efficiency to be obtained by positioning the magnets 10 and 12 as close as possible at top dead centre. In the engines of the previous embodiments, due to wear which may take place in bearings, etc, it may be necessary to provide periodical adjustment if a closed tolerant specification has been adopted. The present embodiment does not require that type of maintenance and therefore gives the engine an additional characteristic which goes with the fact that it can be produced as a cheap intermittent use engine.

In the three above engine embodiments the two methods of activating the valves 16 shown in FIGS. 5 and 6 are adaptable to each. In each case, the appropriate method is dependent on the rev range, efficiency and production cost chosen. FIG. 5 preferably is driven by a cam positioned central to the central axis of each engine embodiment, in the case of the first and second engine, FIGS. 8 to 12 and FIG. 13, a rotary cam, is used and in the case of the third engine, FIG. 14, a stationary cam.

The second method of actuating the valves, FIGS. 6 and 7, also is adaptable to the three engine embodiments, in the same format as described above.

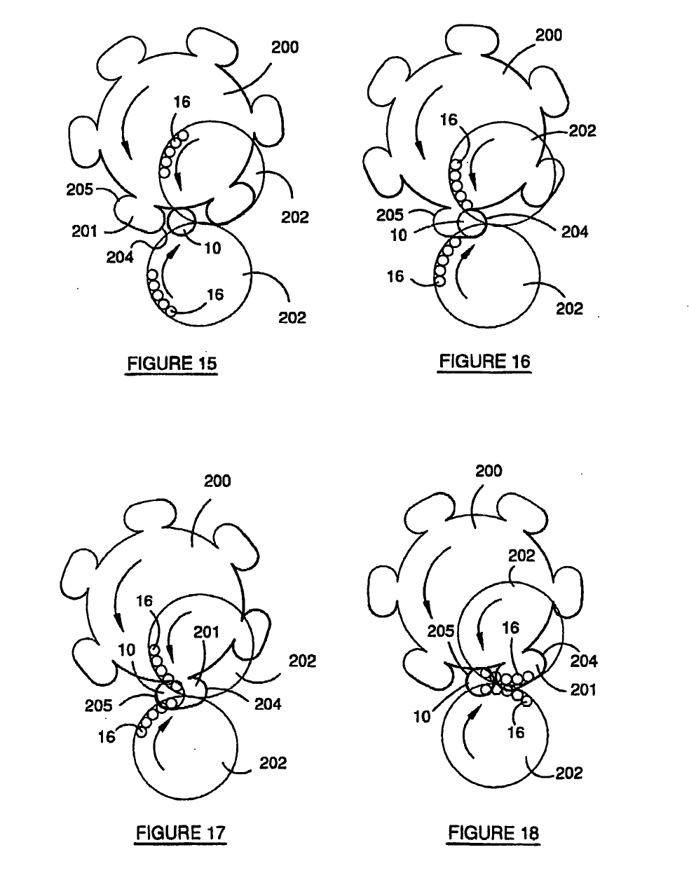

FIGS. 15 to 25 show a further embodiment of the invention which is based on a rotary principle rather than a reciprocating principle as in the earlier embodiments. FIGS. 15 to 18 illustrate the principle of this embodiment. Like reference numerals indicate like parts to those previously described.

In this embodiment, a power disc 200 is provided which is mounted for rotation about its central axis. The power disc 200 has a plurality of teeth 201 formed about its periphery. A permanent magnet 10 is arranged at a peripheral point of the power disc 200 and fixed stationary. Valve discs 202 are provided for rotation about their axes and are arranged between the power disc 200 and the permanent magnet 10. As can be seen clearly in FIG. 15, the discs 202 have a peripheral portion which overlaps the magnet 10.

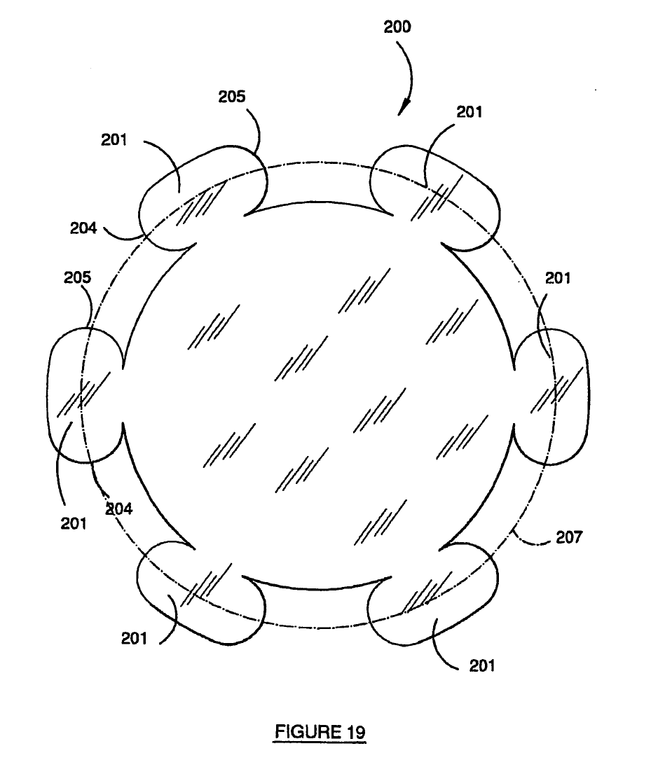

The power disc 200 is shown in more detail in FIG. 19 and the teeth 201 can be seen in more detail. Each of the teeth 201 comprises a generally elongate segment at the periphery of the power disc 200 which has a leading edge 204 and a trailing edge 205. The leading edge 204 and the trailing edge 205 are convex semi circular in shape and have the same radius as the magnet 10 so that the profile of the leading edge 204 and the trailing edge 205 exactly matches the circular profile of the magnet 10, as can be clearly seen in FIG. 15.

The dimensions of the power disc 200 and the valve discs 202 are determined by the amount of encroachment needed by the valve discs over the head magnet 10 to obtain maximum efficiency. The tooth 201 has to be long enough so that after the tooth has completed its power stroke, being 6 mm further after it passes across the magnet 10, so that its trailing edge 205 then does not reach the edge of the magnet 10 which is start of withdrawal until the distance has passed that is needed to rotate the valves into their engaged position. The distance in the embodiment is 60 mm.

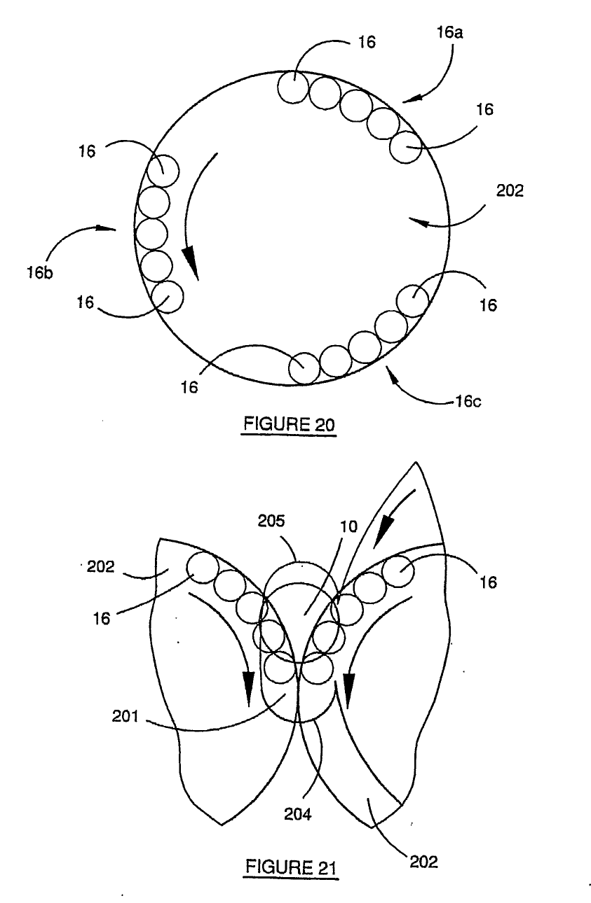

As is shown in FIG. 20, each valve disc 202 is provided with three arrays of valves 16a, 16b and 16c. Each array includes five valves 16 formed from ferromagnetic material as in the earlier embodiment.

FIG. 21 is an enlarged view of part of the illustration in FIG. 15 showing the overlap of the valve discs 202 to the magnet 10 and also the disposition of the power disc 200. It should be understood that only part of the power disc 200 is shown because of its relative size compared to the magnet 10 and the valve discs 200.

Returning to FIG. 15, the diameter of the power disc 200 is approximately twice the diameter of the valve discs 202. The power disc 200 is rotated at approximately half the rotary speed of the valve discs 202 which results in approximately the same linear speed at the periphery of the discs 200 and 202. Preferably, the entire power disc 200 is made from ferromagnetic material but, in other embodiments, only the teeth 202 could be made from ferromagnetic material if desired. The valve discs 202 are made from non-ferrous material and, as previously mentioned, the valves 16 are formed from ferromagnetic material as in the previous embodiment. In FIGS. 15 to 18, it should be understood that only one tooth 201 is specifically shown, and one array of valves 16 is shown on the valve disc 202 simply for ease of illustration. In FIG. 15, the tooth 201 is about to encroach over the magnet 10, and this produces the power stroke of the engine. At this point, the valves 16 on the discs 202 are some distance away from arriving over the magnet 10. The attraction of the tooth 201 to the magnet 10 starts a few millimetres before the tooth 201 reaches the magnet 10.

FIG. 16 shows the power disc 200 has rotated, so that the tooth 201 is now over the head magnet 10 by approximately 6 mm where the attraction of the tooth 201 towards the magnet 10 ceases. The attraction of the power disc 200 from the position shown in FIG. 15 to the position shown in FIG. 16 produces the power stroke of the engine. As can be seen in FIG. 16, the valves 16 are about to enter over the magnet 10 to facilitate movement of the tooth 201 away from the magnet 10.

As shown in FIG. 17, the valve discs 202 have been rotated so that the valves 16 now overlap the magnet 10 and the power disc 200 is in position where the trailing edge 205 is about to arrive at the magnet 10. In this position, the valves 16 fully encroach over the magnet 10 and cause a relocateation of the flux of the magnet 10 similar to that which has been described with reference to the embodiment of FIGS. 1 to 14. The relocateation of the flux away from the tooth 201 neutralises approximately 70% of the force that would normally act against withdrawal of the tooth 201 away from the magnet 10 (or in other words, continued rotation of the power disc 200 in the direction of arrows A in FIGS. 15 and 17, so as to move the tooth 201 away from the magnet 10). Thus, the amount of attraction produced by the magnet 10 which pulls the tooth 201 towards the magnet is greater than the attraction on the tooth 201 when the tooth passes over the magnet 10 and begins to leave the magnet 10, thereby providing net force or power in the direction of arrow A in FIGS. 15 and 17 to drive the disc 200 and to produce an output from the engine.

In FIG. 21, it can be seen that a large area of the perimeter of the magnet 10 is not covered by the valves 16 during the operation of this embodiment. In this embodiment where the tooth is withdrawn across the same plane as the surface of the magnet 10, this exposed section of magnet perimeter is under the trailing edge 205 of the tooth 201, and there is little resistance during the early stage of withdrawal of the tooth trailing edge 205 as it moves from the rear edge of the exposed magnet 10 until the trailing edge 205 reaches approximately halfway across the magnet 10. Any gain which would be achieved by placing valves 16 on the exposed areas of the magnet 10 would not be cost effective because complicated components would be required. The resistance to movement of the tooth 201 away from the magnet 10 starts to escalate at approximately halfway across the magnet 10. However, the tooth 201 is over the area of the magnet 10 where the perimeter of the magnet is fully covered by the valves 16.

As the power disc 200 continues to rotate and the tooth. 201 moves away from the magnet 10, as is shown in FIG. 18, one of the valves 16′ on each of the valve discs 202 is left covering part of the surface of the magnet 10. The purpose of this valve 16′ is to neutralise the influence of the flux behind the rear of the tooth 201 which would otherwise further add to the negative withdrawal force needed to remove the tooth 201 from the proximity of the magnet.

The two trailing valves 16′ also leave the magnet still position clear and behind the tooth 201, as can be seen in FIG. 18. These valves 16′ also leave the magnet under attraction by the magnet 10. Because the tooth 201 is in withdrawal mode away from the magnet 10, a negative force is created. The magnetic force needed to withdraw the two trailing valves 16′ is slightly more than the positive force at which the two trailing valves 16′ entered. This differential is approximately 5% of the engine power stroke, and this loss is less than the reciprocating embodiment described with reference to FIGS. 1 to 14 which produce an operational loss of about 25% due to the need to move the valves 16 during reciprocating movement of the magnets in the embodiments of FIGS. 1 to 14.

The other four valves 16 in each array of valves all enter the area of the magnet 10 while first passing under the inner area of the power disc, then between the magnet 10 and the tooth 201 of the power disc 200. All the surfaces of the power disc are ferromagnetic which has the effect of neutralising any attraction the magnet 10 would normally have to the valves 16, so the valves 16 enter onto the magnet 10 with zero effect on output.

When the four valves 16 leave the surface of the magnet 10, they also leave between the surface of the magnet 10 and the tooth 201. As is seen in FIG. 21 where only one valve 16 is partially withdrawn, the same neutralising effect on the flux is present, therefore there is zero effect on output during withdrawal of these valves 16.

This additional gain by the saving in valve operation in this embodiment is responsible for the increase in efficiency of the engine of this embodiment which totals approximately 70% as opposed to the 50% of the previous embodiment.

An additional phenomena which needs to be addressed in the operation of the present embodiment is that on entry into the magnet 10, each trailing valve 16 has to have a gap of approximately 0.4 mm between it and the valve 16 that it follows. If not, on entry to the magnet 10, the preceding valve, already in contact with the magnet 10 will become magnetised which, in turn, would magnetise a trailing valve which, in turn, would neutralise the attraction to the magnet 10 by the valve, and this scenario if not addressed would cause an overall power loss of about 15%. The operational length of the tooth 201 measured along its pitch circle 207 (see FIG. 19) occupies a distance of approximately 32°. A gap between teeth of approximately half of the magnet diameter is preferred behind the central point on the trailing edge 205 of the tooth 201 so the next approaching tooth entering onto the magnet 10 is not influenced by the magnetised material of the previous tooth 201 and valves 16, which would cause a loss of output in the approaching tooth 201.

As is apparent from a consideration of FIGS. 19, 20 and 21, the power disc 200 has six teeth 201 and each valve disc has three arrays, 16a, 16b and 16c of valves 16. As the power disc 201 is twice the diameter of the valve discs 202 and rotates at half the speed of the discs 202, each valve array on the valve disc 202 arrives over the head magnet 10 with two of the teeth on the power disc 200 during one revolution of the power disc 200. As is also apparent from these figures, and also FIGS. 15 to 18, the spacing of the arrays 16a, 16b and 16c is such that as each tooth 201 arrives at the magnet 10, one of the arrays 16a, 16b and 16c on each of the discs 202 interacts with the tooth 201 and magnet 10, as shown in FIGS. 15 to 18.

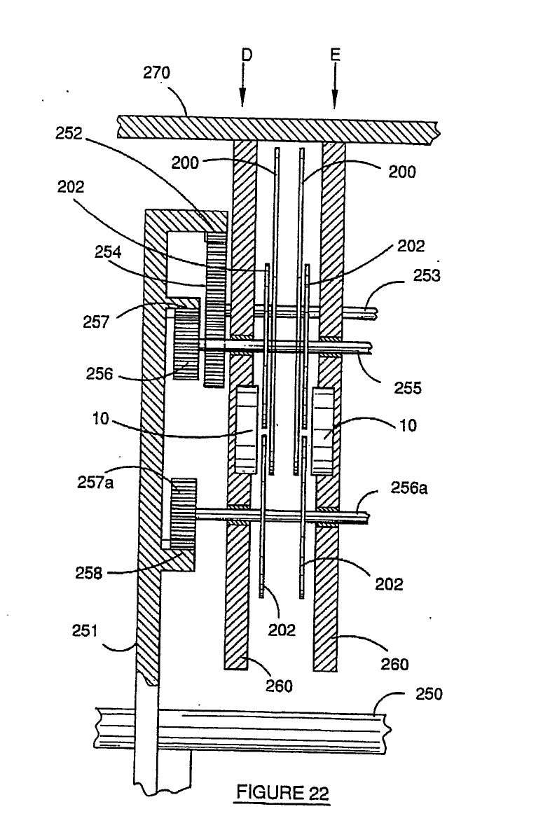

FIGS. 22 to 25 show in more detail an embodiment of an engine according to the principles of FIGS. 15 to 21.

FIG. 22 is a cross sectional view through the operating parts of the engine. The engine includes a main output shaft 250 from which rotary output power will be provided from the engine. The shaft 250 carries a bull wheel disc 251 which in turn mounts an outer ring gear 252. A first axle 253 carries a pinion gear 254 which meshes with the internal teeth of the ring gear 252. A second axle 255 carries a pinion gear 256 which meshes with a further ring gear 257 mounted to the disc 251 radially inwardly of the ring gear 252. A third axle 256a also carries a pinion 257a which meshes with a ring gear 258 mounted further radially inwardly on the disc 251. Thus, in the embodiment shown in FIG. 22, two banks of powered disc assemblies D and E of the type shown in FIGS. 15 to 18 and 21 are provided. Stationary webs 260 are fixed to outer engine frame or casing 270, and each mount a respective permanent magnet 10 of the banks D and E. The axles 255 and 256a each mount one of the valve discs 202 of each bank D and E. The axle 253 mounts the power discs 200 of each bank D and E which are to be associated with each of the respective pairs of respective valve discs 202 and the permanent magnet 10.

Additional banks could also be added by simply adding further webs which mount additional permanent magnets 10, and additional valve discs 202 on the axles 255 and 256a and additional power discs 200 on the axle 253.

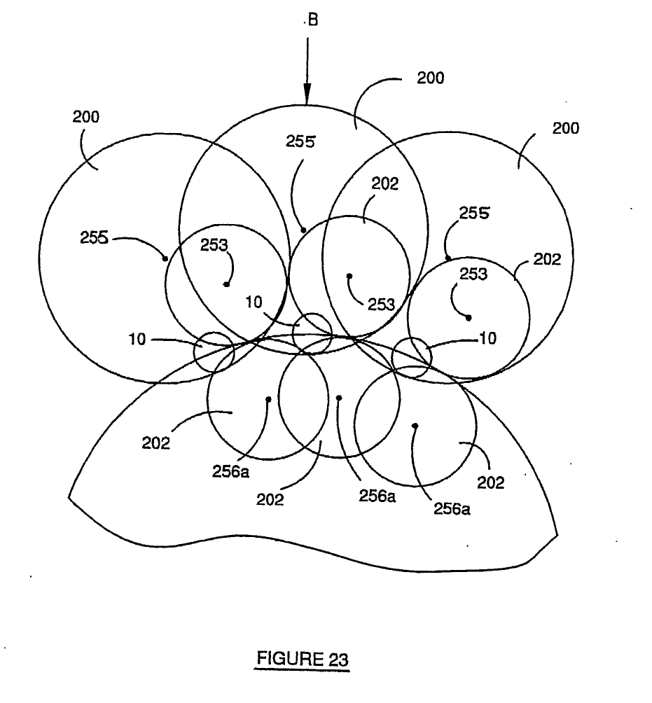

As is described above, each of the banks D and E is shown to include only a single power disc 200 together with its associated pair of valve discs 202 and permanent magnet 10. However, as is shown in FIG. 23, each of the banks may include an array of power disc assemblies, each formed by a magnet 10, a pair of valve discs 202 and a power disc 200. In order to provide the array, a plurality of the axles 253, 255 and 256a are arranged circumferentially about the disc 251 for mounting each of the assemblies of the array, as is shown in FIG. 23.

In the preferred embodiment, a total of 16 assemblies could be mounted peripherally around the disc 251. As is shown in FIG. 23, the middle assembly labelled B in FIG. 23 overlaps with the other two assemblies, and in order to provide for this overlapping relationship, assembly B (and the other second assembly) are set back approximately 5 mm from the assemblies on each side of that assembly.

The power discs 200 are rotated in the manner previously described to produce the net output because of the increased attraction of the teeth 201 towards the magnet 10 as the teeth approach the magnet 10, compared to the attraction which occurs when the teeth 201 move away from the magnet 10 in view of the disposition of the valve 16 over the magnet 10 in the latter movement. Thus, a net output is provided to each of the power discs 200 which rotates the discs 200 to thereby rotate the respective axles 253. Rotation of the axles 253 rotates the pinions 254 which in turn drives the ring gear 252, and therefore the disc 251 to rotate the output shaft 250 to thereby provide output rotary power from the engine. Because the pinions 256 and 257a also mesh with ring gears 257 and 258 which are fixed onto the disc 251, the valve discs 202 are rotated in time with the discs 200 so as to overlap the valves 16 with the magnets 10 in synchronisation with the teeth 201, as described with reference to FIGS. 15 to 18.

The valve disc 202 and the power disc 200 are the components which determine the engine rev limit because the perimeters of these discs are moving at approximately four times the speed of the pinion and ring gears. Due to the light weight of the discs 201 and 202, and their relatively small diameters, high rpm capabilities exist. Because the rotary speed of these components may exceed practical working speeds of conventional teeth on pinion and ring gear sets, problems could arise due to the deep penetration of conventional interconnecting gear teeth, which at extremely high speeds could produce problems with lubricant, for example, hydraulic lock due to excess lubricant not being able to be dispersed quick enough. The gears in this embodiment have extremely large gear ratios of around 16:1 which approach borderline mechanical efficiency with such gear drives and could cause undue wear. For these reasons, purpose designed gear teeth are preferred in the pinion gears and ring gear sets previously described.

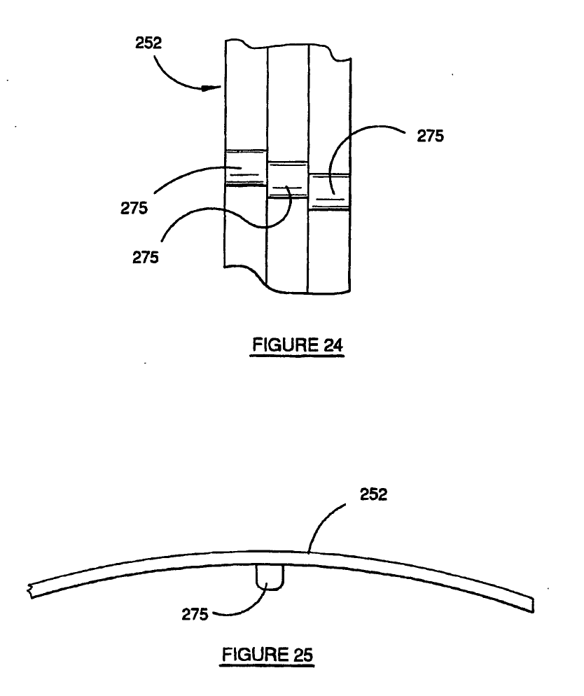

FIGS. 24 and 25 show an embodiment of the preferred teeth configuration of the ring gears 252, 257 and 258, and also the pinions 254, 256 and 257a. In FIG. 24, the ring gear 252 is shown. The ring gear carries gear teeth 275 which are arranged in three rows, as shown in FIG. 24. More rows could be provided if desired. The corresponding pinion gears have corresponding rows of teeth. The three rows are one third the height of a conventional tooth of the same pitch. In a conventional gear tooth, principle meshing of the gears involves deep interlocking of the teeth, which allows a long duration of rolling action between the teeth as this contact continues until the next interconnecting pair of teeth come into contact, therefore providing a smooth transition as there is continual contact. With the short teeth 275, more of a simple nudge is provided rather than the conventional rolling interlock, which is more ideal for high speed operations. The three rows of teeth 275 shown in FIG. 24 are staggered one third of a tooth width back from each other, and this arrangement results in a three stage transition of rotary motion from the pinion gears to the ring gears. The combination of the three stage transition and the shorter rolling duration caused by the shorter tooth length results in a smooth transition between the pinion gears and the ring gears equivalent to conventional gearing. In this embodiment, lubrication for the pinion gears or ring gears may be provided through the centre of the pinion gears and to overcome possible hydraulic lock, the lubricant quality could be metered. The lubricant would enter the tooth surface through a multi array of ports dotted over the gear teeth surfaces and centrifugal force would propel the lubricant onto the corresponding ring gear teeth as the teeth start to come into mesh with the pinion gears.

In the embodiment of FIGS. 15 to 25, electrical eddy currents may be produced in the teeth 201 as they pass the magnets 10. This could cause losses in the output from the engine. This phenomena is somewhat similar to that which occurs in electrical motor armatures. In order to avoid this phenomena producing a detrimental effect on the output from the engine, the teeth 201 could be laminated so as to break up the eddy currents into very small currents, thereby minimising any loses. In the embodiment of FIGS. 14 and 15, the magnet 10 preferably has a diameter of about 32 mm and the ring gear 252 may have a size of about 500 mm. The main advantage of the configuration shown in FIGS. 15 to 25 is the higher efficiency of the engine compared to that in the previous embodiments.

1. An engine including:
a first permanent magnet;
a second element movable relative to the magnet towards and away from the magnet;
an output for providing output rotary power due to relative movement between the magnet and the element; and
flux altering means for movement into and out of registry with the magnet for relocating magnetic flux produced by the magnet away from the element so that when the flux altering means is registered with the magnet, the flux produced by the magnet and to which the element is exposed is decreased, and upon movement of the flux altering means out of registry with the magnet, the magnetic flux of the magnet to which the element is exposed is increased, thereby providing a larger force between the magnet and the element to provide the output rotary power at the output.

2. The engine of claim 1 wherein the element comprises a second permanent magnet mounted for reciprocating movement with respect to the first permanent magnet, and the output is coupled to the second permanent magnet to convert the reciprocating movement of the second permanent magnet to rotary movement at the output.

3. The engine of claim 1 wherein the element comprises a ferromagnetic element which is attracted towards the magnet and which passes the magnet, and wherein as the element passes the magnet, the flux altering means moves into registry with the magnet to reduce the attraction between the magnet and the element to thereby enable the element to continue past the magnet to provide output rotary power at the output.

4. The engine of claim 1 wherein the first permanent magnet has a hole so the magnet produces a doughnut shaped flux around the hole, and wherein the flux altering means, when in registry with the magnet, relocates that flux to a position outwardly of the magnet.

5. An engine including:
a first permanent magnet;
a piston including a second permanent magnet, the second magnet being arranged with respect to the first magnet so that same poles of the first and second magnets face one another;
mounting means for mounting the piston and second magnet for reciprocating movement relative to the first magnet;
an output coupled to the piston for providing output power; and
flux altering means for movement into and out of registry with the first permanent magnet for relocating magnetic flux produced by the first magnet away from the second magnet, so that when the flux altering means is registered with the first magnet, the magnetic flux produced by the first magnet and to which the second magnet is exposed is decreased, and upon movement of the flux altering means out of registry with the magnet, the magnetic flux of the first magnet to which the second magnet is exposed is increased thereby providing a larger repelling force between the first and second magnets to thereby provide an output power stroke.

6. The engine of claim 5 wherein the flux altering means comprises a plurality of discrete elements, and means for guiding movement of the discrete elements from a position adjacent a periphery of the first magnet, to a position inwardly of the periphery of the first magnet.

7. The engine of claim 6 wherein the elements are formed from magnetisable material.

8. The engine of claim 6 or 7 wherein the elements are in the form of discs.

9. The engine of claim 5 wherein the first and second magnetics are each provided with a central hole.

10. The engine of claim 5 wherein the mounting means comprises a pair of guide rails coupled to the piston, and at least one bearing for guiding reciprocating movement of the guide rails and the piston.

11. The engine of claim 10 wherein the guide rails have a U-shaped end portion connecting the guide rails together.

12. The engine of claim 11 wherein the end portion is pivotally connected to a connecting rod at one end of the connecting rod, and the other end of the connecting rod is connected to the output.

13. The engine of claim 5 wherein the output comprises a crank shaft.

14. The engine of claim 5 wherein the flux altering means includes drive means for driving the flux altering means into registry with the first magnet and out of registry with the first magnet in synchronisation with the reciprocating movement of the piston.

15. The engine of claim 14 wherein the drive means comprises:
a rotatable element mounted for rotation in a first direction and then rotation in a second direction;
a link coupled to the rotatable element and driven by rotation of the crank shaft so as to cause the rotatable element to rotate back and forward in the said direction and reverse direction; and
a link coupled to the flux altering means and to the rotatable element so that upon rotation of the rotatable element in the first direction, the flux altering means is moved to a position adjacent the periphery of the first magnet, and upon rotation in the reverse direction, is moved to a position inward of the periphery of the first magnet.

16. The engine of claim 5 wherein the flux altering means has a guide element for guiding movement of the flux altering means.

17. The engine of claim 16 wherein the guide element comprises a hollow sleeve which receives a stem connected to the flux altering means for guiding movement of the flux altering means.

18. The engine of claim 5 wherein the flux altering means is moved by a cam member which rotates in synchronisation with the output so as to move the flux altering means between the position adjacent the periphery of the first magnet to the position inwardly of the first magnet.

19. The engine of claim 18 wherein movement of the flux altering means in one direction is partly assisted by magnetic attraction of the first magnet so that movement of the flux altering means in said direction produces energy which is harnessed and supplied as output energy from the engine.

20. The engine of claim 19 wherein the flux altering means is coupled to a spring in which the energy is stored.

21. The engine of claim 5 wherein the first permanent magnet has a hole so the magnet produces a doughnut shaped flux around the hole, and wherein the flux altering means, when in registry with the magnet, relocates that flux to a position outwardly of the magnet.

22. An engine including:
a first permanent magnet;
a piston including a second permanent magnet, the second magnet being arranged with respect to the first magnet so that same poles of the first and second magnets face one another;
mounting means for mounting the piston and second magnet for reciprocating movement relative to the first magnet;
an output coupled to the piston for providing output power;
flux altering means for movement into and out of registry with the first permanent magnet so that when the flux altering means is registered with the first magnet the magnetic flux produced by the first magnet and to which the second magnet is exposed is decreased, and upon movement of the flux altering means out of registry with the magnet, the magnetic flux of the first magnet to which the second magnet is exposed is increased thereby providing a larger repelling force between the first and second magnets to thereby provide an output power stroke; and
wherein the first permanent magnet is a substantially circular shape and has a central hole which has a diameter one third of the diameter of the first magnet, and wherein the flux altering means, when in registry with the first magnet, encroaches on the first magnet by an amount of 20% of the radius of the first magnet, and wherein the flux altering means comprises a plurality of generally circular elements which have a diameter one third of the diameter of the first magnet.

23. The engine of claim 22 wherein the flux altering means relocates the flux from the first magnet away from the second magnet when the flux altering means is in registry with the first magnet.

24. The engine of claim 22 wherein the flux altering means comprises a plurality of discrete elements, and means for guiding movement of the discrete elements from a position adjacent a periphery of the first magnet, to a position inwardly of the periphery of the first magnet.

25. The engine of claim 24 wherein the elements are formed from magnetisable material.

26. An engine including:
a reciprocating piston;
a rotary output member for supplying output rotary power;
connecting means for connecting the reciprocating piston to the output rotary member so that reciprocation of the piston produces rotation of the output member; and
dwell angle producing means for producing a flat dwell angle whilst the piston is at a top dead centre position so that the rotary output member rotates a significant portion of the rotary cycle of the output member before substantial movement of the piston from top dead centre position occurs so that as the piston moves away from top dead centre position under maximum power during a power stroke, the angle between the connecting means and the rotary output member approaches a maximum value so that power is delivered from the reciprocating piston whilst the piston is subject to increased force in the power stroke and whilst the angle between the connecting means and the output rotary member approaches the maximum to thereby increase output efficiency from the engine.

27. The engine of claim 26 wherein the piston includes a magnet and reciprocating movement of the piston is caused by magnetic repulsion from a further magnet.

28. The engine of claim 26 wherein the piston may be powered by combustion of fuel in a cylinder to cause reciprocation of the piston in the cylinder.

29. The engine of claim 26 wherein the coupling means comprises a connecting rod and the output rotary member comprises a crank shaft, the crank shaft having an output axel coupled to a primary crank, a secondary crank for receiving the primary crank, the connecting rod being connected to the secondary crank by a crank pin, a gear mounted in the secondary crank, and a secondary gear for meshing engagement with the gear supported by the secondary crank so that the connection between the connecting rod and the crank pin executes an elliptical path having a generally flat path portion as the piston approaches and leaves top dead centre position and wherein as the crank shaft rotates, no substantial movement of the piston occurs from top dead centre position whilst the point of connection between the connecting rod and the crank pin follows the flat path and as the connection leaves the flat path portion of the elliptical path, the angle the connecting rod makes with the plane passing through the rotary axis of the engine increases towards a maximum so that maximum power of the reciprocating piston in the power stroke is supplied to the crank while the angle approaches maximum angle to thereby increase the power delivered to the crank shaft from the piston.

30. The engine of claim 26 wherein the piston is coupled to a guide roller, the rotary output member comprises a cam plate, the guide roller engaging the cam plate, the cam plate having a cam surface which is engaged by the roller, and the cam plate having a generally flat portion which prevents movement of the piston, and an inclined portion which, when engaged with the roller, results in the roller exerting a force which is at an angle to the tangent of the inclined profile so that force is imparted to the cam plate whilst maximum force is applied to the piston in the power stroke to thereby deliver maximum force to the rotary cam plate to rotate the cam plate.

31. An engine including:
a rotary power member having a plurality of separated elements, each element being formed from a magnetically attractably material;
a permanent magnet arranged adjacent the member and overlapping the elements when the member rotates relative to the magnet;
at least one flux altering member for movement into and out of registry with the magnet in synchronisation with the rotation of the rotating power member; and
wherein magnetic attraction of the magnet draws the elements in turn towards the magnet, thereby causing rotation of the rotary power member, and whereupon as the respective elements arrive at the magnet, the flux altering members are moved into registry with the magnet to decrease the magnetic attraction between the elements and the magnet so that the rotary power member can continue to rotate to allow the respective elements to move away from the magnet after they pass the magnet, thereby providing a net output in the direction of rotation of the rotary power member.

32. The engine of claim 31 wherein the engine includes a pair of said flux altering members, each movable into and out of registry with the magnet in synchronisation with the rotation of the rotary power member.

33. The engine of claim 31 wherein the rotary power member comprises a disc and the elements comprise a plurality of teeth arranged at the periphery of the disc.

34. The engine of claim 33 wherein each of the teeth includes a leading edge and a trailing edge, the leading edge and the trailing edge having a contoured shape which matches the periphery of the permanent magnet.

35. The engine of claim 32 wherein each of the flux altering members comprises a disc having a plurality of arrays of ferromagnetic elements.

36. The engine of claim 35 wherein the engine includes means for rotating the flux altering discs at twice the speed of the rotary power member, and wherein the flux altering discs have a diameter which is substantially half that of the rotary power member, so the periphery of the flux altering discs and the rotary power member travel at substantially the same speed.

37. The engine of claim 36 wherein the rotary power member is mounted on an axle, the axle carrying a pinion, a ring gear in mesh with the pinion so that rotation of the rotary power member rotates the axle to in turn cause the pinion to rotate the ring gear, the ring gear being connected to the output for rotating the output to thereby provide rotary output power at the output.

38. The engine of claim 37 wherein the ring gear is coupled to a mounting disc and the mounting disc carries a second and third ring gear, the flux altering discs, each being mounted on an axle, each axle having a pinion for engaging a respective one of the second and third ring gears, so that upon rotation of the disc, the second and third axles are rotated to thereby rotate the flux altering discs in synchronisation with the rotary power member to selectively bring the flux altering elements into and out of registry with the permanent magnet.

39. The engine of claim 31 wherein the engine includes a plurality of banks of rotary power member assemblies, each assembly including a respective said permanent magnet and a respective said pair of flux altering members.

40. The engine of claim 31 wherein the first permanent magnet has a hole so the magnet produces a doughnut shaped flux around the hole, and wherein the flux altering means, when in registry with the magnet, relocates that flux to a position outwardly of the magnet.
